(19) United States
(12) Patent Application Publication
(10) Pub. No.: US 2026/0037182 A1
(43) Pub. Date: Feb. 5, 2026

(54) WRITING OF MULTI-LEVEL CELL DATA TRAFFIC

(71) Applicant: Microchip Technology Incorporated, Chandler, AZ (US)

(72) Inventors: Nian Niles YANG, Mountain View, CA (US); Pitamber SHUKLA, San Jose, CA (US); Srinivas YELISETTI, Fremont, CA (US)

(21) Appl. No.: 18/988,880

(22) Filed: Dec. 19, 2024

Related U.S. Application Data
(60) Provisional application No. 63/679,083, filed on Aug. 2, 2024.

(51) Int. Cl. G06F 3/06

(52) U.S. Cl. CPC G06F 3/0659; G06F 3/0619; G06F 3/0656; G06F 3/0679

(57) ABSTRACT

A storage device may receive a first page of data traffic at a first buffer of a storage medium. The storage device may write, from the first buffer, the first page of the data traffic to a first block having a first cell level. The storage device may receive, during the writing of the first page, a second page of the data traffic at a second buffer of the storage medium. The storage device may write, from the second buffer, the second page of the data traffic to a second block having the first cell level. The storage device may write, from the first buffer and the second buffer without an additional transfer to the storage medium of the data traffic, the first page and the second page of the data traffic to an MLC block having a second cell level that is greater than the first cell level.

### RELATED APPLICATION

This application claims priority to U.S. Provisional Patent Application No. 63/679,083 entitled “WRITING OF MULTI-LEVEL CELL DATA TRAFFIC,” filed Aug. 2, 2024, which is incorporated herein by reference in its entirety.

### FIELD

The present disclosure generally relates to a storage device that is capable of performing operations using at least a first cell level and a second cell level. For example, the storage device may be capable of performing read/write operations using two or more of single-level cell (SLC), multi-level cell (MLC), triple-level cell (TLC), quad-level cell (QLC), or penta-level cell (PLC), among other examples. In some examples, the write operation may include writing host data on a first set of lower cell level blocks for error detection and on a higher cell level block for longer storage of the host data. In some examples, the host data stored on the first set of lower cell level blocks may be erased after performing error detection on the higher cell level block.

### BACKGROUND

A storage device may include one or more storage media that may store and retain data without external power supply. One example of a storage device is a negative-and (NAND) flash memory device where the one or more storage media include one or more NANDs. The storage device may include non-volatile storage (e.g., NANDs) and volatile storage (e.g., double data rate (DDR) storage).

The storage device may store data as bits within the storage device (e.g., within the non-volatile storage). For example, the storage device may include transistors that store bit values. In some aspects, the storage device may include cells (e.g., associated with one or more transistors) that store bit values. To write bits to the cells, the storage device may apply a write or program voltage to transistors such that a read operation associated with the transistors produces a read voltage associated with the bits. Cells may be single-level cells (SLC) associated with a first cell level or a multi-level cell (MLC) associated with an cell level that is at least two. For example, an MLC may include a two-level cell, a three level cell (e.g., triple-level cell (TLC)), a four level cell (e.g., quad-level cell (QLC)), or a five level cell (e.g., penta-level cell (PLC)), among other examples.

### SUMMARY

In some implementations, a method performed by a storage device includes receiving a first page of data traffic at a first buffer of a storage medium. The method includes writing, from the first buffer, the first page of the data traffic to a first block having a first cell level. The method includes receiving, during the writing of the first page, a second page of the data traffic at a second buffer of the storage medium. The method includes writing, from the second buffer, the second page of the data traffic to a second block having the first cell level. The method includes writing, from the first buffer and the second buffer without an additional transfer to the storage medium of the data traffic, the first page and the second page of the data traffic to an MLC block having a second cell level that is greater than the first cell level.

In some implementations, a system comprises controller of a non-volatile memory device (e.g., a storage device). The controller may be configured to receive a first page of multi-level cell (MLC) data traffic at a first buffer of a storage medium. The controller may be configured to write, from the first buffer, the first page of the data traffic to a first block having a first cell level. The controller may be configured to receive, during the writing of the first page, a second page of the data traffic at a second buffer of the storage medium. The controller may be configured to write, from the second buffer, the second page of the data traffic to a second block having the first cell level. The controller may be configured to write, from the first buffer and the second buffer without an additional transfer to the storage medium of the data traffic, the first page and the second page of the data traffic to an MLC block having a second cell level that is greater than the first cell level.

In some implementations, a computer program product comprises one or more computer readable storage media and program instructions collectively stored on the one or more computer readable storage media. The program instructions comprise program instructions to receive a first page of multi-level cell (MLC) data traffic at a first buffer of a storage medium. The program instructions comprise program instructions to write, from the first buffer, the first page of the data traffic to a first block having a first cell level. The program instructions comprise program instructions to receive, during the writing of the first page, a second page of the data traffic at a second buffer of the storage medium. The program instructions comprise program instructions to write, from the second buffer, the second page of the data traffic to a second block having the first cell level. The program instructions comprise program instructions to receive, during the writing of the second page, a third page of the data traffic at a third buffer of the storage medium. The program instructions comprise program instructions to write, from the third buffer, the third page of the data traffic to a third block having the first cell level. The program instructions comprise program instructions to write, from the first buffer, the second buffer, and the third buffer without an additional transfer to the storage medium of the data traffic, the first page, the second page, and the third page of the data traffic to an MLC block having a second cell level that is greater than the first cell level.

### BRIEF DESCRIPTION OF THE DRAWINGS

FIG. 1 is a diagram of an example of writing of multi-level cell data traffic described herein.

FIG. 2 is a diagram of an example of writing of multi-level cell data traffic described herein.

FIG. 3 is a diagram of example components of one or more devices of FIGS. 1-2.

FIGS. 4-6 are flowcharts of example processes associated with writing multi-level cell data traffic described herein.

### DETAILED DESCRIPTION

The following detailed description of example implementations refers to the accompanying drawings. The same reference numbers in different drawings may identify the same or similar elements.

A non-volatile memory device (e.g., a negative-and (NAND) memory device, also referred to as storage media) may store data based at least in part on write operations initiated by a controller. The controller may include one or more of an application specific integrated circuit (ASIC) or firmware. In some examples, the storage media and the controller may be included in a storage device.

Writing using a multi-level cell (MLC) (e.g., a two-level cell, a triple-level cell (TLC), a quad-level cell (QLC), or a penta-level cell (PLC), among other examples) may result in an increased likelihood of errors. To mitigate the increased likelihood of errors and to assist in error correction, data may be written as lower cell level (e.g., a single-level cell (SLC)) data on additional blocks of a storage medium, the data may be written as MLC data (e.g., TLC data, QLC data, PLC data, among other examples), and the lower cell level data may be used for error detection and correction of the MLC data. After the error detection and correction of the MLC data, the lower cell level data may be erased based at least in part on the lower cell level data being redundant.

A process for writing the data as lower cell level data and then MLC data may include multiple transfers of the host data, with at least one transfer for each of the cell levels of the data (e.g., two) that are used to write the data. This may result in consumption of computing resources and may occupy channels or a storage medium interface that may prevent other operations from being performed.

In some aspects described herein, the storage device may transfer first page data to the storage medium (e.g., NAND). The storage device may receive the first page data at a first page buffer that is on the storage medium. The storage device may begin to program the first page data to a lower cell level block (e.g., SLC block) from the first page data transfer. This may occur during a transfer of second page data to the storage medium. The storage device may receive the second page data at a second page buffer that is on the storage medium. The storage device may program the second page data to a second lower cell level block during a transfer of third page data to the storage medium. The storage device may receive the third page data at a third page buffer that is on the storage medium. The storage device may program the third page data to a third lower cell level block during a transfer of fourth page data to the storage medium. The storage device may receive the fourth page data at a fourth page buffer that is on the storage medium. The storage device may program the fourth page data to a fourth lower cell level block. After all 4 pages have been programmed with the 4 pages of data, the storage device may begin to program the data (e.g., all 4 pages) to a higher cell level block (e.g., the MLC, such as a QLC block) using MLC data programming from the page buffers. In this way, the storage device may, during a single data transfer, program both lower cell level (e.g., SLC) and higher cell level (e.g., QLC) data to the storage medium. This may conserve computing resources of the storage device and reduce occupation of a channel or interface that may then be available for other operations of the storage device.

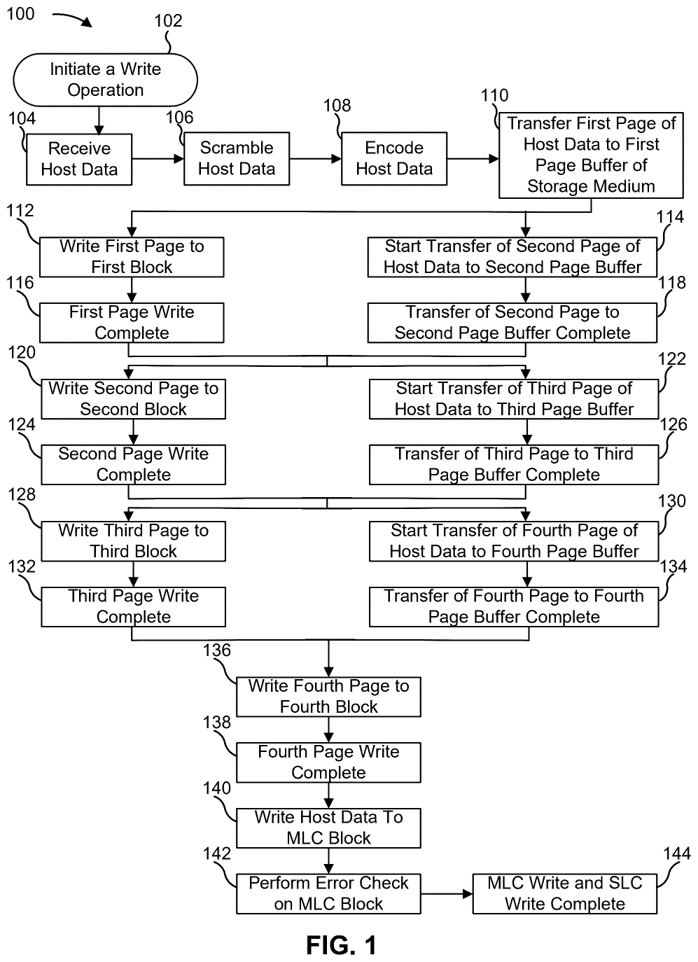

FIG. 1 is a diagram of an example 100 of writing of multi-level cell data traffic described herein. Multi-level cell data traffic is data traffic that is to be stored in multi-level cells of the storage medium (e.g., cells configured for MLC, TLC, QLC, or PLC, among other examples). The operations described in connection with example 100 may be performed by a storage device, or one or more components of the storage device, such as a controller or storage medium, among other examples. Although examples may be described in connection with FIG. 1 as an SSD or NAND device, other storage devices are intended to be interchangeable in the context of the described aspects and examples. For example, the storage device may include, or may be included in, a NOR flash memory device, an electrically erasable programmable read-only memory (EEPROM), or another storage device that uses program and program verification operations, among other examples.

FIG. 1 illustrates a scenario where the MLC write operation is a QLC write operation. However, other cell levels of MLC write operations may also be used. Additionally, or alternatively, the multiple page write operations are described in connection with SLC write operations to SLC blocks. However, other cell levels of write operations may be used, wherein a cell level used is lower than a cell level of the final write operation (e.g., described as the MLC or the QLC write operation).

As shown in FIG. 1, and by reference number 102, a storage device may initiate a write operation (e.g., a program operation). In some aspects, the storage device may receive a request to perform the write operation from a host device.

As shown by reference number 104, the storage device may receive host data. In some aspects, the storage device may receive the host data along with an indication of one or more parameters for storage of the host data. For example, the one or more parameters may include a logical address that the host will use to identify the host data or a service level agreement that identifies performance parameters (e.g., error rates or latency) associated with the host data.

As shown by reference number 106, the storage device may scramble the host data. For example, the storage device may apply encoding or transformation to the host data. In this way, the data may be stored with improved security and integrity. As shown by reference number 108, the storage device may encode the host data. In this way, the storage device may protect the data from security threats and from errors. Additionally, or alternatively, encoding the host data may compress the data or provide error correction capabilities for a subsequent read of the host data.

As shown by reference number 110, the storage device may transfer a first page of the host data to a first page buffer of a storage medium.

As shown by reference number 112, the storage device may write the first page to a first block within the storage medium.

As shown by reference number 114, the storage device may start a transfer of a second page of the host data to a second page buffer. The storage device may start the transfer of the second page of the host data before completion of the first page write to the first block.

As shown by reference number 116, the storage device may achieve first page write completion once the storage device completes the associated write operation within the storage medium.

As shown by reference number 118, the storage device may achieve transfer of the second page to the second page buffer completion once the storage device finishes a transfer of the second page to the second page buffer of the storage medium. In some aspects, the first page write operation may be completed before transfer of the second page to the second page buffer is completed. In some aspects, the first page write operation may be completed after transfer of the second page to the second page buffer is completed.

As shown by reference number 120, the storage device may write the second page to a second block within the storage medium. In some aspects, the second block may be associated with a lower cell level than an MLC block described below in connection with reference number 140. For example, the second block may have a same cell level (e.g., 1) as the first block.

As shown by reference number 122, the storage device may start a transfer of a third page of the host data to a third page buffer. The storage device may start the transfer of the third page of the host data before completion of the second page write to the second block.

As shown by reference number 124, the storage device may achieve second page write completion once the storage device completes the associated write operation within the storage medium.

As shown by reference number 126, the storage device may achieve transfer of the third page to the third page buffer completion once the storage device finishes a transfer of the third page to the third page buffer of the storage medium. In some aspects, the second page write operation may be completed before transfer of the third page to the third page buffer is completed. In some aspects, the second page write operation may be completed after transfer of the third page to the third page buffer is completed.

As shown by reference number 128, the storage device may write the third page to a third block within the storage medium. In some aspects, the third block may be associated with a lower cell level than an MLC block described below in connection with reference number 140. For example, the third block may have a same cell level (e.g., 1) as the first block and the second block.

As shown by reference number 130, the storage device may start a transfer of a fourth page of the host data to a fourth page buffer. The storage device may start the transfer of the fourth page of the host data before completion of the third page write to the third block.

As shown by reference number 132, the storage device may achieve third page write completion once the storage device completes the associated write operation within the storage medium.

As shown by reference number 134, the storage device may achieve transfer of the fourth page to the fourth page buffer completion once the storage device finishes a transfer of the fourth page to the fourth page buffer of the storage medium. In some aspects, the third page write operation may be completed before transfer of the fourth page to the fourth page buffer is completed. In some aspects, the third page write operation may be completed after transfer of the fourth page to the fourth page buffer is completed.

As shown by reference number 136, the storage device may write the fourth page to a fourth block within the storage medium. In some aspects, the fourth block may be associated with a lower cell level than an MLC block described below in connection with reference number 140. For example, the fourth block may have a same cell level (e.g., 1) as the first block, the second block, and the third block.

As shown by reference number 138, the storage device may achieve fourth page write completion once the storage device completes the associated write operation within the storage medium.

As shown by reference number 140, the storage device may write the host data to an MLC block. For example, the storage device may write the host data to the MLC block using the pages of data stored in the buffers of the storage medium during the transfer and write operations associated with a lower cell level write operation described in connection with reference numbers 110-136. In this way, the storage device does not transfer the host data multiple times to write to the lower cell level blocks and to the MLC block. This may conserve computing resources, channel traffic, or interface traffic to the storage medium.

As shown by reference number 142, the storage device may perform an error check on the MLC block. For example, the storage device may test the MLC block to identify bits stored on the MLC block. The storage device may also test the first block, second block, third block, and fourth block as part of respective write operations to the first through fourth blocks to identify errors on bits stored on the lower cell level blocks. In this way, the storage device may write the first through fourth pages with a relatively low likelihood of program errors (e.g., relatively low compared to write operations at higher cell levels).

In some aspects, the storage device may compare bits of the MLC block with bits stored in the first, second, third, and fourth blocks (e.g., lower cell level block) to identify errors within the MLC block for correction (e.g., with the MLC block being more likely to have an error if there is a discrepancy in the reads). In this way, the storage device may use the first, second, third, and fourth write operations to provide a more reliable (e.g., less likely to have errors) copy of the data that is written to the MLC block. This may allow the storage device to store the data in a more efficient scheme (e.g., MLC or higher cell level block) while maintaining an error rate that is similar to a lower cell level scheme.

As shown by reference number 144, the storage device may achieve an MLC write and SLC (e.g., or other lower cell level) write completion. As shown in FIG. 1, the storage device uses a single transfer of the host data to a storage medium (e.g., NAND) to achieve MLC and SLC write completion instead of using transfers to the storage medium for each of the MLC write and the SLC write operations. The single transfer may include sending the data to the storage medium once and the storage medium writes to both SLC and MLC (e.g., MLC, TLC, QLC, or PLC, among other example). This provides an improved efficiency compared to writing to SLC blocks with a first transfer and having a controller read from the SLC blocks into the controller, perform ECC correction, and then transfer back the data to the storage medium for an MLC write. In this case, the storage device may reduce a process from using three transfers between the controller and the storage medium to using one transfer.

The operations shown in FIG. 1 or described in connection with the operations are provided as an example.

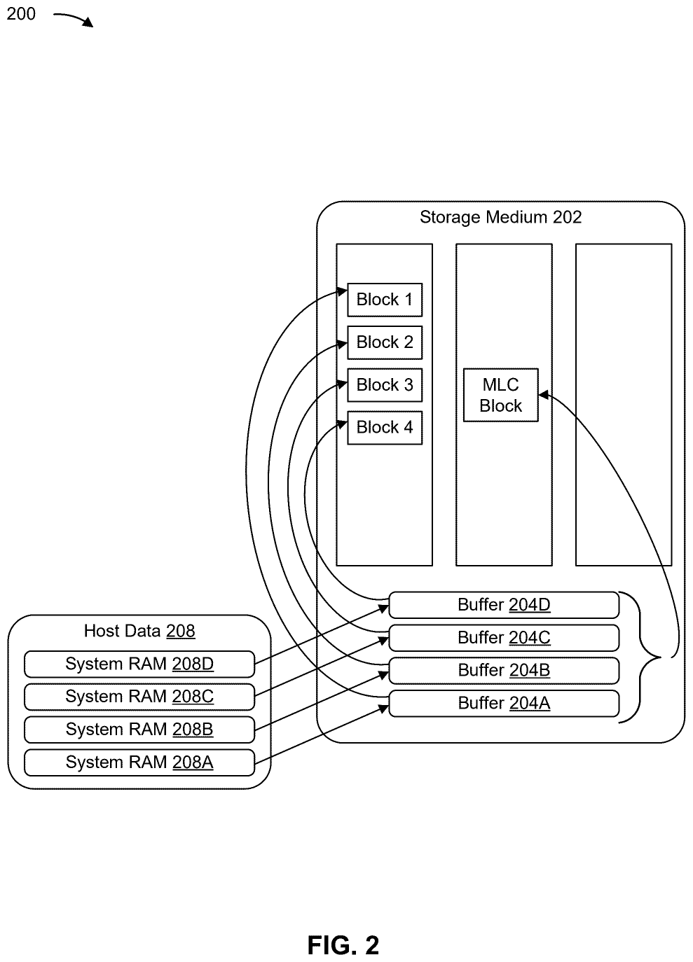

FIG. 2 is a diagram of an example 200 of writing of multi-level cell data traffic described herein. The operations described in connection with example 200 may be performed by a storage device, or one or more components of the storage device, such as a controller or storage medium, among other examples.

FIG. 2 illustrates a scenario where the MLC write operation is a QLC write operation. However, other cell levels of MLC write operations may also be used. Additionally, or alternatively, the multiple page write operations are described in connection with SLC write operations to SLC blocks. However, other cell levels of write operations may be used, wherein a cell level used is lower than a cell level of the final write operation (e.g., described as the MLC or the QLC write operation).

As shown in FIG. 2, a storage device may include a storage medium 202 that includes multiple sets of blocks and a set of buffers shown, for example, as 204A, 204B, 204C, and 204D. The buffers may be used to temporarily store data that is to be written to one or more blocks within the storage medium 202.

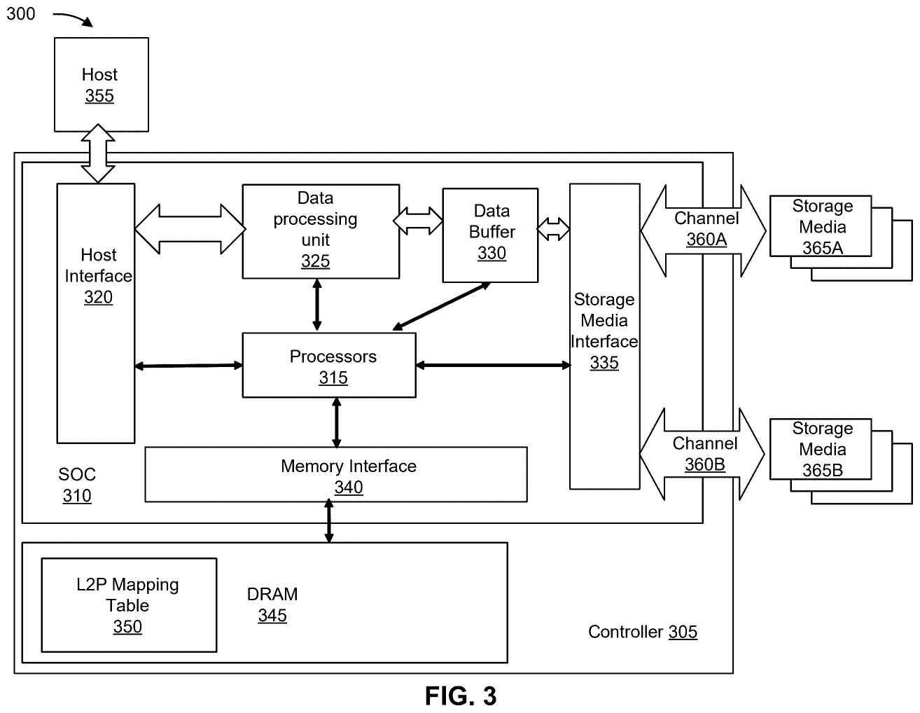

The storage device may provide host data 208 to the storage medium 202. For example, the storage device may temporarily store the host data in system random access memory (RAM) (e.g., memory on, or accessible to, a system on chip (SOC) of a controller of the storage medium, such as data buffer 330 or DRAM 345 of FIG. 3). The host data 208 may be stored in system RAM that includes system RAM 208A (e.g., a first page), system RAM 208B (e.g., a second page), system RAM 208C (e.g., a third page), and system RAM 208D (e.g., a fourth page). The storage medium 202 may store the first page associated with system RAM 208A in buffer 204A, the second page associated with system RAM 208B in buffer 204B, the third page associated with system RAM 208C in buffer 204C, and the fourth page associated with system RAM 208D in buffer 204D. In some aspects, system RAM 208 may be on a controller side of the storage device and the buffers 204A-D may be on a storage medium side of the storage device. Each of the buffers may be associated with a different lower cell level block of the storage medium 202 (e.g., blocks 1, 2, 3, 4).

In some aspects, the host data may transfer the pages associated with system RAMs sequentially. For example, the storage medium 202 may receive the first page into the buffer 204A. Then, during transfer of the second page, the storage medium 202 may write the first page to block 1. During transfer of the third page, the storage medium 202 may write second page to block 2. During transfer of the fourth page, the storage medium 202 may write the third page to block 3. Then, the storage medium 202 may write the fourth page to block 4. Once completed with writing all of the pages to blocks 1-4 (e.g., the lower cell level blocks), the storage medium 202 may write all of the pages as higher cell level data to the MLC block using the pages that are already stored in the buffers. In this way, the storage medium uses a single transfer of the pages of data to the storage medium to write both the lower cell level blocks and the MLC block.

The number and arrangement of components shown in FIG. 2 are provided as an example.

FIG. 3 is a diagram of example components of a storage device 300, which may correspond to one or more devices of FIGS. 1-2. In some implementations, the storage device 300 may include one or more devices 200 or one or more components of device 200. In some aspects, the device 200 may include one or more storage devices 300 or one or more components of storage device 300.

As shown in FIG. 3, the storage device 300 may include a controller 305 (e.g., an SSD controller). The controller 305 may include a system on chip (SOC) 310. The SOC 310 may perform computing or processing operations for the controller 305.

The SOC 310 may include one or more processors 315 that control, command, or observe operations at one or more other components of the SOC 310. The one or more processors 315 may be communicably coupled too one or more of a host interface 320, a data processing unit 325, a data buffer 330 a storage medium interface 335, or a memory interface 340.

The host interface 310 may be configured to communicate with a host device (e.g., host device 355 described below). The DPU 325 may manage data flow between the host interface 310 and storage media. The DPU 325 may further include a functional block that is responsible for managing data operations, such as reading, writing, error correction, or formatting. The DPU 325 may perform tasks such as page and block management (e.g., organization of data within storage media), bad block management, garbage collection, error correction and detection (e.g., using error correction codes or soft bit processing), data transformation (e.g., address mapping from host addresses to physical addresses, compression and decompression, or scrambling, among other examples), encryption and decryption, or power management associated with data operations, among other examples.

The data buffer 330 is a pipeline data buffer for the data transition. The data buffer 330 may include a temporary storage area used to transfer or process data between the storage media and a host system. The memory interface 340 is an interface between controller 310 and external DDR or DRAM, which may be used to temporarily hold the data. The memory interface 340 may provide an interface between the SOC 310 and the DRAM 345 to facilitate transfers of information. For example, the memory interface 340 may support requests to access a logical to physical (L2P) mapping table to identify a physical location of data requested by the host device, or to provide mapping information for storage in the L2P mapping table.

The controller 305 may further include DRAM 345. The DRAM 345 may locally store information that is available on demand at the controller 305 for operations of the controller 305. For example, the DRAM 345 may store an L2P mapping table 350 that maps logical locations of data and physical locations of data on connected storage media. In this way, the controller 305 may have access to mapping information for locating data on the connected storage media based at least in part on an indication associated with host data when written. In some aspects, additional RAM (e.g., system RAM) may be stored on, or accessible to, the controller 305 or the SOC 310. In some aspects, the DRAM 345 may include the system RAM or the system RAM may include a different chip.

The host interface 320 may provide an interface for communicating with a host 355. For example, the host interface 320 may receive an access request or data for storage on connected storage media. In some aspects, the host interface 320 may provide data to the host after reading the data on from the connected storage media.

The storage media interface 335 may communicate via one or more channels 360 (e.g., 360A and 360B) with one or more connected storage media 365 (e.g., 365A and 365B). For example, the controller 305 may perform or initiate a read or write operation at a physical location of a storage media device 365. In some aspects, the controller 305 may write multi-level cell data traffic using a single data transfer to a storage medium of the storage medium 365A or 365B. The storage medium may correspond to storage medium 202 of FIG. 2 and may perform operations described in connection with FIG. 1.

Device 300 may perform one or more processes described herein. For example, a non-transitory computer-readable medium (e.g., memory 345 or storage component 365) may store a set of instructions (e.g., one or more instructions, code, software code, or program code) for execution by processor 315. Processor 315 may execute the set of instructions to perform one or more processes described herein. In some implementations, execution of the set of instructions, by one or more processors 315, causes the one or more processors 315 or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example.

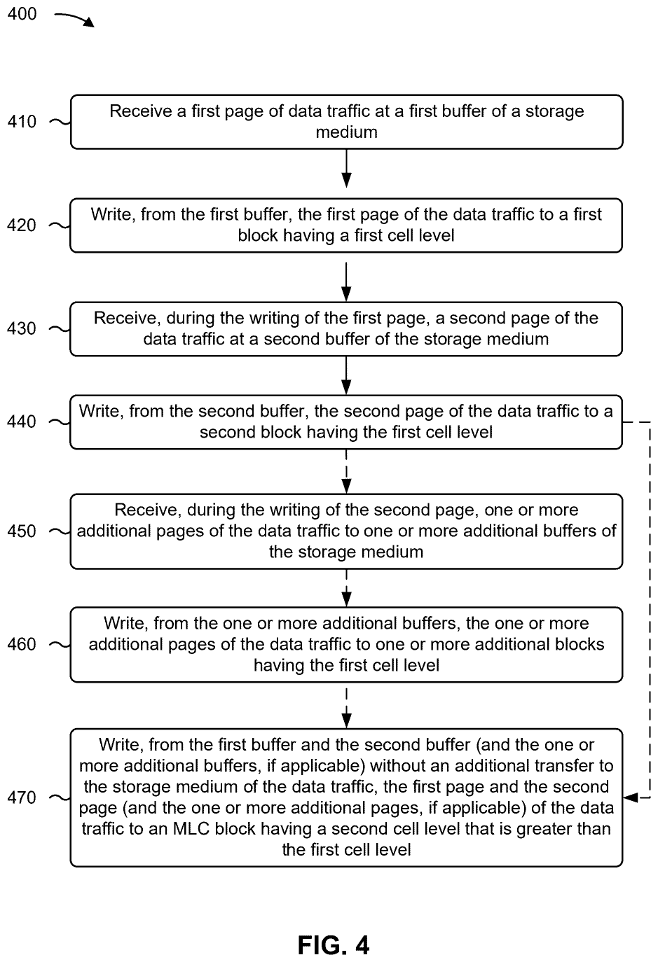

FIG. 4 is a flowchart of an example process 400 associated with writing of multi-level cell data traffic field. In some implementations, one or more process blocks of FIG. 4 may be performed by a storage device (e.g., storage device 300). In some implementations, one or more process blocks of FIG. 4 may be performed by another device or a group of devices separate from or including the storage device, such as a storage medium 202 or a controller 305. Additionally, or alternatively, one or more process blocks of FIG. 4 may be performed by one or more components of device 300, such as processors 315, storage media interface 335, channels 360A-B or the SOC 310, among other examples.

As shown in FIG. 4, process 400 may include receiving a first page of data traffic at a first buffer of a storage medium (block 410). For example, the storage device may receive a first page of data traffic at a first buffer of a storage medium, as described above.

As further shown in FIG. 4, process 400 may include writing, from the first buffer, the first page of the data traffic to a first block having a second cell level that is lower than the second cell level (block 420). For example, the storage device may write, from the first buffer, the first page of the data traffic to a first block having a second cell level that is lower than the second cell level, as described above.

As further shown in FIG. 4, process 400 may include receiving, during the writing of the first page, a second page of the data traffic at a second buffer of the storage medium (block 430). For example, the storage device may receive, during the writing of the first page, a second page of the data traffic at a second buffer of the storage medium, as described above.

As further shown in FIG. 4, process 400 may include writing, from the second buffer, the second page of the data traffic to a second block having the second cell level (block 440). For example, the storage device may write, from the second buffer, the second page of the data traffic to a second block having the second cell level, as described above.

As further shown in FIG. 4, process 400 may include receiving, during the writing of the second page, one or more additional pages of the data traffic at one or more additional buffers of the storage medium (block 450). For example, in the case where MLC is TLC, the storage device may receive, during the writing of the second page, a third page of the data traffic at a third buffer of the storage medium, as described above. In the case where MLC is QLC, the storage device may receive, during the writing of the third page, a fourth page of the data traffic at a fourth buffer of the storage medium, as described above. In the case where MLC is PLC, the storage device may receive, during the writing of the fourth page, a fifth page of the data traffic at a fifth buffer of the storage medium, as described above. In some cases, the one or more additional pages of the data traffic may include more than five pages and the storage device may receive the one or more additional pages as described herein.

As further shown in FIG. 4, process 400 may include writing, from the one or more additional buffers, the one or more additional pages of the data traffic to one or more additional blocks having the second cell level (block 460). For example, in the case where MLC is TLC, the storage device may write, from the third buffer of the storage medium, the third page of the data traffic to the third block having the second cell level as described above. In the case where MLC is QLC, the storage device may write, from the fourth buffer of the storage medium, the fourth page of the data traffic to a fourth block having the second cell level. In the case where MLC is PLC, the storage device may write, from the fifth buffer of the storage medium, the fifth page of the data traffic to a fifth block having the second cell level. In some cases, the one or more additional buffers of the data traffic may include more than five buffers and the storage device may write the one or more additional pages as described herein.

As further shown in FIG. 4, process 400 may include writing, from the first buffer and the second buffer without an additional transfer to the storage medium of the data traffic, the first page and the second page of the data traffic to an MLC block having a second cell level that is greater than the first cell level (block 470). For example, the storage device may write, from the first buffer and the second buffer without an additional transfer to the storage medium of the data traffic, the first page and the second page of the data traffic to an MLC block having a second cell level that is greater than the first cell level, as described above.

Process 400 may include additional implementations, such as any single implementation or any combination of implementations described below and/or in connection with one or more other processes described elsewhere herein.

In a first implementation, process 400 includes performing an error check for the MLC block based at least in part on the data traffic stored on the first block and the second block.

In a second implementation, alone or in combination with the first implementation, process 400 includes programming the data traffic on the MLC block after performing the error check.

In a third implementation, alone or in combination with one or more of the first and second implementations, process 400 includes receiving, during the writing of the second page, a third page of the data traffic to a third buffer of the storage medium, writing, from the third buffer, the third page of the data traffic to a third block having the second cell level, and writing, from the third buffer, the third page of the MLC data buffer to the MLC block without an additional transfer to the storage medium of the data traffic further, wherein writing the first page, the second page, and the third page to the MLC block comprises writing the first page, the second page, and the third page to the MLC block after writing the third page of the data traffic to the third block having the second cell level.

In a fourth implementation, alone or in combination with one or more of the first through third implementations, process 400 includes receiving, during the writing of the third page, a fourth page of the data traffic at a fourth buffer of the storage medium, writing, from the fourth buffer, the fourth page of the data traffic to a fourth block having the second cell level, and writing, from the fourth buffer, the fourth page of the MLC data buffer to the MLC block without an additional transfer to the storage medium of the data traffic further, wherein writing the first page, the second page, the third page, and the fourth page to the MLC block comprises writing the first page, the second page, the third page, and the fourth page to the MLC block after writing the fourth page of the data traffic to the fourth block having the second cell level.

In a fifth implementation, alone or in combination with one or more of the first through fourth implementations, process 400 includes erasing the data traffic from the first block and the second block after writing the first page and the second page of the data traffic to the MLC block.

In a sixth implementation, alone or in combination with one or more of the first through fifth implementations, the second cell level comprises a two-level cell, a triple-level cell (TLC), a quad-level cell (QLC), or a penta-level cell (PLC).

In a seventh implementation, alone or in combination with one or more of the first through sixth implementations, the second cell level comprises a single-level cell (SLC), a triple-level cell (TLC), or a quad-level cell (QLC).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

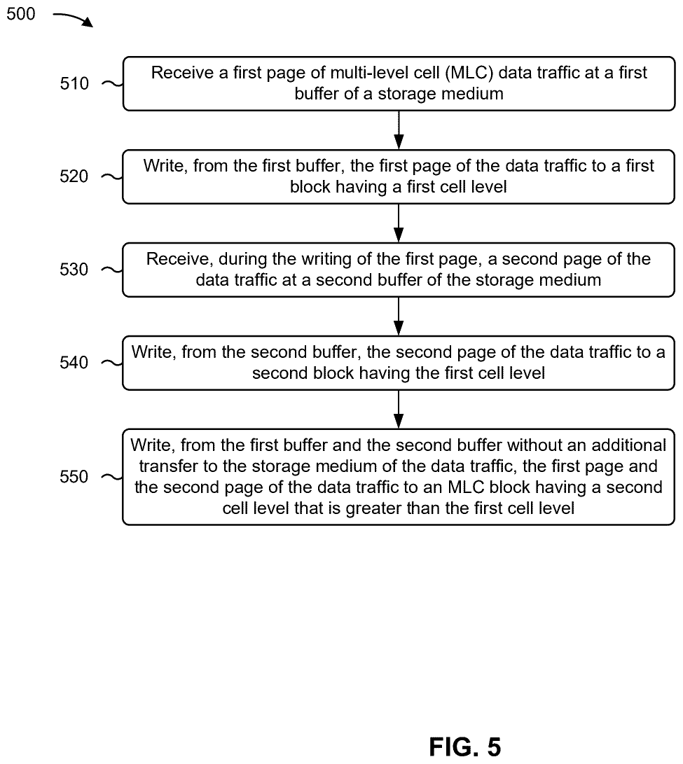

FIG. 5 is a flowchart of an example process 500 associated with writing of multi-level cell data traffic field. In some implementations, one or more process blocks of FIG. 5 may be performed by a storage device (e.g., storage device 300). In some implementations, one or more process blocks of FIG. 5 may be performed by another device or a group of devices separate from or including the storage device, such as a storage medium 202 or a controller 305. Additionally, or alternatively, one or more process blocks of FIG. 5 may be performed by one or more components of device 300, such as processors 315, storage media interface 335, channels 360A-B or the SOC 310, among other examples. In some aspects, a system may include a controller of a non-volatile memory device (e.g., storage device) configured to perform operations described in connection with process 500.

As shown in FIG. 5, process 500 may include receiving a first page of MLC data traffic at a first buffer of a storage medium (block 510). For example, the storage device may receive a first page of MLC data traffic at a first buffer of a storage medium, as described above.

As further shown in FIG. 5, process 500 may include writing, from the first buffer, the first page of the data traffic to a first block having a first cell level (block 520). For example, the storage device may write, from the first buffer, the first page of the data traffic to a first block having a first cell level (e.g., the block or the data may be associated with the first cell level), as described above.

As further shown in FIG. 5, process 500 may include receiving, during the writing of the first page, a second page of the data traffic at a second buffer of the storage medium (block 530). For example, the storage device may receive, during the writing of the first page, a second page of the data traffic at a second buffer of the storage medium, as described above.

As further shown in FIG. 5, process 500 may include writing, from the second buffer, the second page of the data traffic to a second block having the first cell level (block 540). For example, the storage device may write, from the second buffer, the second page of the data traffic to a second block having the first cell level, as described above.

As further shown in FIG. 5, process 500 may include writing, from the first buffer and the second buffer without an additional transfer to the storage medium of the data traffic, the first page and the second page of the data traffic to an MLC block having a second cell level that is greater than the first cell level (block 550). For example, the storage device may write, from the first buffer and the second buffer without an additional transfer to the storage medium of the data traffic, the first page and the second page of the data traffic to an MLC block having a second cell level (e.g., the MLC block or the data may be associated with the second cell level) that is greater than the first cell level, as described above.

Process 500 may include additional implementations, such as any single implementation or any combination of implementations described below and/or in connection with one or more other processes described elsewhere herein.

In a first implementation, process 500 includes performing an error check for the MLC block based at least in part on the data traffic stored on the first block and the second block.

In a second implementation, alone or in combination with the first implementation, process 500 includes receiving, during the writing of the second page, a third page of the data traffic at a third buffer of the storage medium, writing, from the third buffer, the third page of the data traffic to a third block having the first cell level, and writing, from the third buffer, the third page of the MLC data buffer to the MLC block without an additional transfer to the storage medium of the data traffic further, wherein writing the first page, the second page, and the third page to the MLC block comprises writing the first page, the second page, and the third page to the MLC block after writing the third page of the data traffic to the third block having the first cell level.

In a third implementation, alone or in combination with one or more of the first and second implementations, process 500 includes receiving, during the writing of the third page, a fourth page of the data traffic at a fourth buffer of the storage medium, writing, from the fourth buffer, the fourth page of the data traffic to a fourth block having the first cell level, and writing, from the fourth buffer, the fourth page of the MLC data buffer to the MLC block without an additional transfer to the storage medium of the data traffic further, wherein writing the first page, the second page, the third page, and the fourth page to the MLC block comprises writing the first page, the second page, the third page, and the fourth page to the MLC block after writing the fourth page of the data traffic to the fourth block having the first cell level.

In a fourth implementation, alone or in combination with one or more of the first through third implementations, process 500 includes erasing the data traffic from the first block and the second block after writing the first page and the second page of the data traffic to the MLC block.

In a fifth implementation, alone or in combination with one or more of the first through fourth implementations, the second cell level comprises a triple-level cell (TLC), a quad-level cell (QLC), or a penta-level cell (PLC).

In a sixth implementation, alone or in combination with one or more of the first through fifth implementations, the first cell level comprises a single-level cell (SLC), a triple-level cell (TLC), or a quad-level cell (QLC).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

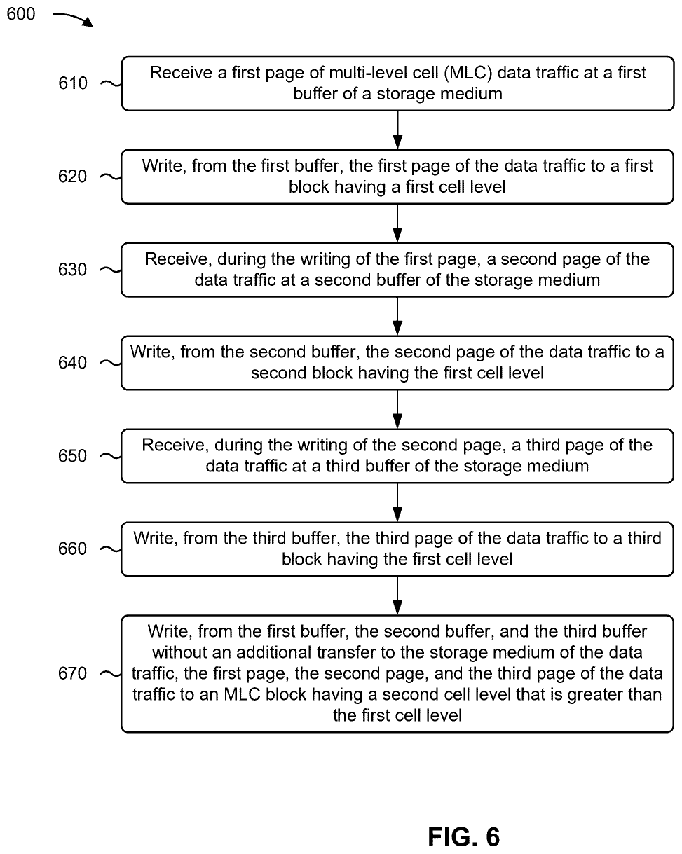

FIG. 6 is a flowchart of an example process 600 associated with writing of multi-level cell data traffic field. In some implementations, one or more process blocks of FIG. 6 may be performed by a storage device (e.g., storage device 300). In some implementations, one or more process blocks of FIG. 6 may be performed by another device or a group of devices separate from or including the storage device, such as a storage medium 202 or a controller 305. Additionally, or alternatively, one or more process blocks of FIG. 6 may be performed by one or more components of device 300, such as processors 315, storage media interface 335, channels 360A-B or the SOC 310, among other examples. In some aspects, a system may include a controller of a non-volatile memory device (e.g., storage device) configured to perform operations described in connection with process 600.

As shown in FIG. 6, process 600 may include receiving a first page of MLC data traffic at a first buffer of a storage medium (block 610). For example, the storage device may receive a first page of MLC data traffic at a first buffer of a storage medium, as described above.

As further shown in FIG. 6, process 600 may include writing, from the first buffer, the first page of the data traffic to a first block having a first cell level (block 620). For example, the storage device may write, from the first buffer, the first page of the data traffic to a first block having a first cell level, as described above.

As further shown in FIG. 6, process 600 may include receiving, during the writing of the first page, a second page of the data traffic at a second buffer of the storage medium (block 630). For example, the storage device may receive, during the writing of the first page, a second page of the data traffic at a second buffer of the storage medium, as described above.

As further shown in FIG. 6, process 600 may include writing, from the second buffer, the second page of the data traffic to a second block having the first cell level (block 640). For example, the storage device may write, from the second buffer, the second page of the data traffic to a second block having the first cell level, as described above.

As further shown in FIG. 6, process 600 may include receiving, during the writing of the second page, a third page of the data traffic at a third buffer of the storage medium (block 650). For example, the storage device may receive, during the writing of the second page, a third page of the data traffic at a third buffer of the storage medium, as described above.

As further shown in FIG. 6, process 600 may include writing, from the third buffer, the third page of the data traffic to a third block having the first cell level (block 660). For example, the storage device may write, from the third buffer, the third page of the data traffic to a third block having the first cell level, as described above.

As further shown in FIG. 6, process 600 may include writing, from the first buffer, the second buffer, and the third buffer without an additional transfer to the storage medium of the data traffic, the first page, the second page, and the third page of the data traffic to an MLC block having a second cell level that is greater than the first cell level (block 670). For example, the storage device may write, from the first buffer, the second buffer, and the third buffer without an additional transfer to the storage medium of the data traffic, the first page, the second page, and the third page of the data traffic to an MLC block having a second cell level that is greater than the first cell level, as described above.

Process 600 may include additional implementations, such as any single implementation or any combination of implementations described below and/or in connection with one or more other processes described elsewhere herein.

In a first implementation, process 600 includes performing an error check for the MLC block based at least in part on the data traffic stored on the first block and the second block.

In a second implementation, alone or in combination with the first implementation, process 600 includes programming the data traffic on the MLC block after performing the error check.

In a third implementation, alone or in combination with one or more of the first and second implementations, process 600 includes receiving, during the writing of the second page, a third page of the data traffic at a third buffer of the storage medium, writing, from the third buffer, the third page of the data traffic to a third block having the first cell level, and writing, from the third buffer, the third page of the MLC data buffer to the MLC block without an additional transfer to the storage medium of the data traffic further, wherein writing the first page, the second page, and the third page to the MLC block comprises writing the first page, the second page, and the third page to the MLC block after writing the third page of the data traffic to the third block having the first cell level.

In a fourth implementation, alone or in combination with one or more of the first through third implementations, process 600 includes erasing the data traffic from the first block and the second block after writing the first page and the second page of the data traffic to the MLC block.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems or methods described herein may be implemented in different forms of hardware, firmware, or a combination of hardware and software. The actual control hardware or software code used to implement these systems or methods is not limiting of the implementations. Thus, the operation and behavior of the systems or methods are described herein without reference to specific software code—it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with other claims in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein is to be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method performed by a storage device, the method comprising:
receiving a first page of data traffic at a first buffer of a storage medium;
writing, from the first buffer, the first page of the data traffic to a first block having a first cell level;
receiving, during the writing of the first page, a second page of the data traffic at a second buffer of the storage medium;
writing, from the second buffer, the second page of the data traffic to a second block having the first cell level; and
writing, from the first buffer and the second buffer without an additional transfer to the storage medium of the data traffic, the first page and the second page of the data traffic to an MLC block having a second cell level that is greater than the first cell level.

2. The method of claim 1, comprising:
performing an error check for the MLC block based at least in part on the data traffic stored on the first block and the second block.

3. The method of claim 2, comprising:
programming the data traffic on the MLC block after performing the error check.

4. The method of claim 1, comprising:
receiving, during the writing of the second page, a third page of the data traffic at a third buffer of the storage medium;
writing, from the third buffer, the third page of the data traffic to a third block having the first cell level; and
writing, from the third buffer, the third page of the MLC data buffer to the MLC block without an additional transfer to the storage medium of the data traffic further,
wherein writing the first page, the second page, and the third page to the MLC block comprises writing the first page, the second page, and the third page to the MLC block after writing the third page of the data traffic to the third block having the first cell level.

5. The method of claim 4, comprising:
receiving, during the writing of the third page, a fourth page of the data traffic at a fourth buffer of the storage medium;
writing, from the fourth buffer, the fourth page of the data traffic to a fourth block having the first cell level; and
writing, from the fourth buffer, the fourth page of the MLC data buffer to the MLC block without an additional transfer to the storage medium of the data traffic further,
wherein writing the first page, the second page, the third page, and the fourth page to the MLC block comprises writing the first page, the second page, the third page, and the fourth page to the MLC block after writing the fourth page of the data traffic to the fourth block having the first cell level.

6. The method of claim 1, further comprising:
erasing the data traffic from the first block and the second block after writing the first page and the second page of the data traffic to the MLC block.

7. The method of claim 1, wherein the second cell level comprises:
a two-level cell,
a triple-level cell (TLC),
a quad-level cell (QLC), or
a penta-level cell (PLC).

8. The method of claim 1, wherein the first cell level comprises:
a single-level cell (SLC),
a two-level cell,
a triple-level cell (TLC), or
a quad-level cell (QLC).

9. A system comprising:
a controller, of a non-volatile memory device, to:
receive a first page of multi-level cell (MLC) data traffic at a first buffer of a storage medium;
write, from the first buffer, the first page of the data traffic to a first block having a first cell level;
receive, during the writing of the first page, a second page of the data traffic at a second buffer of the storage medium;
write, from the second buffer, the second page of the data traffic to a second block having the first cell level; and
write, from the first buffer and the second buffer without an additional transfer to the storage medium of the data traffic, the first page and the second page of the data traffic to an MLC block having a second cell level that is greater than the first cell level.

10. The system of claim 9, wherein the controller is to:
perform an error check for the MLC block based at least in part on the data traffic stored on the first block and the second block.

11. The system of claim 9, wherein the controller is to:
receive, during the writing of the second page, a third page of the data traffic at a third buffer of the storage medium;
write, from the third buffer, the third page of the data traffic to a third block having the first cell level; and
write, from the third buffer, the third page of the MLC data buffer to the MLC block without an additional transfer to the storage medium of the data traffic further,
wherein writing the first page, the second page, and the third page to the MLC block comprises writing the first page, the second page, and the third page to the MLC block after writing the third page of the data traffic to the third block having the first cell level.

12. The system of claim 11, wherein the controller is to:
receive, during the writing of the third page, a fourth page of the data traffic at a fourth buffer of the storage medium;
write, from the fourth buffer, the fourth page of the data traffic to a fourth block having the first cell level; and
write, from the fourth buffer, the fourth page of the MLC data buffer to the MLC block without an additional transfer to the storage medium of the data traffic further,
wherein writing the first page, the second page, the third page, and the fourth page to the MLC block comprises writing the first page, the second page, the third page, and the fourth page to the MLC block after writing the fourth page of the data traffic to the fourth block having the first cell level.

13. The system of claim 9, wherein the controller is to:
erase the data traffic from the first block and the second block after writing the first page and the second page of the data traffic to the MLC block.

14. The system of claim 9, wherein the second cell level comprises:
a triple-level cell (TLC),
a quad-level cell (QLC), or
a penta-level cell (PLC).

15. The system of claim 9, wherein the first cell level comprises:
a single-level cell (SLC),
a triple-level cell (TLC), or
a quad-level cell (QLC).

16. A computer program product comprising:
one or more computer readable storage media, and program instructions collectively stored on the one or more computer readable storage media, the program instructions comprising:
program instructions to receive a first page of multi-level cell (MLC) data traffic at a first buffer of a storage medium;
program instructions to write, from the first buffer, the first page of the data traffic to a first block having a first cell level;
program instructions to receive, during the writing of the first page, a second page of the data traffic at a second buffer of the storage medium;
program instructions to write, from the second buffer, the second page of the data traffic to a second block having the first cell level;
program instructions to receive, during the writing of the second page, a third page of the data traffic at a third buffer of the storage medium;
program instructions to write, from the third buffer, the third page of the data traffic to a third block having the first cell level; and
program instructions to write, from the first buffer, the second buffer, and the third buffer without an additional transfer to the storage medium of the data traffic, the first page, the second page, and the third page of the data traffic to an MLC block having a second cell level that is greater than the first cell level.

17. The computer program product of claim 16, wherein the program instructions comprise:
program instructions to perform an error check for the MLC block based at least in part on the data traffic stored on the first block and the second block.

18. The computer program product of claim 17, wherein the program instructions comprise:
program instructions to program the data traffic on the MLC block after performing the error check.

19. The computer program product of claim 16, wherein the program instructions comprise:
program instructions to receive, during the writing of the second page, a third page of the data traffic at a third buffer of the storage medium;
program instructions to write, from the third buffer, the third page of the data traffic to a third block having the first cell level; and
program instructions to write, from the third buffer, the third page of the MLC data buffer to the MLC block without an additional transfer to the storage medium of the data traffic further,
wherein writing the first page, the second page, and the third page to the MLC block comprises writing the first page, the second page, and the third page to the MLC block after writing the third page of the data traffic to the third block having the first cell level.

20. The computer program product of claim 16, wherein program instructions comprise:
program instructions to erase the data traffic from the first block and the second block after writing the first page and the second page of the data traffic to the MLC block.
